(19) United States
(12) Patent Application Publication
(10) Pub. No.: US 2007/0223744 A1
(43) Pub. Date: Sep. 27, 2007

(54) ELECTRO-OPTIC DEVICE AND ELECTRONIC APPARATUS

(75) Inventor: Hiroshi WADA, Azumino (JP)

Correspondence Address: HARNESS, DICKEY & PIERCE, P.L.C., P.O. BOX 828, BLOOMFIELD HILLS, MI, 48303, US

(73) Assignee: EPSON IMAGING DEVICES CORPORATION, Tokyo (JP)

(21) Appl. No.: 11/680,138

(22) Filed: Feb. 28, 2007

(30) Foreign Application Priority Data
Mar. 23, 2006 (JP) 2006-080313
Mar. 23, 2006 (JP) 2006-080314

(51) Int. Cl. H04R 25/00; G02F 1/1333

(52) U.S. Cl. 381/152; 349/58

(57) ABSTRACT

An electro-optic device includes a display unit having a display area and a plurality of sound generating members, the plurality of sound generating members each include a speaker which is arranged so as to overlap the display area in plan view, and a sound releasing hole that outputs sounds generated by the speaker toward the outside, wherein the plurality of sound releasing holes which constitutes the plurality of sound generating members are arranged on the outside of the display area in plan view along part of the sides of the display area.

### BACKGROUND

1. Technical Field

The present invention relates to an electro-optic device having a display unit and a plurality of sound generating members, and an electronic apparatus provided with the electro-optic device.

2. Related Art

In recent years, electro-optic devices such as liquid crystal display device are widely provided as a display device for displaying various types of information relating to electronic apparatus as an image in an electronic apparatus such as mobile phones or mobile information terminal. The electro-optic device is a device that controls the state of optical output by electrical input, and examples include liquid crystal display devices, EL (Electra Luminescence) devices, and plasma display devices.

The electronic apparatus also includes means that generates sounds. For example, in the case of the mobile phone, it is necessary to express the content of what a person on the other side of the phone talks with a voice, and hence a sound generating member such as a speaker is provided as the means that generates sounds.

The electronic apparatus provided both with the electro-optic device and the sound generating member is known in the related art. The electronic apparatus provided with a plurality of the sound generating members is also known. (For example, see JP-A-2003-078601, JP-A-2003-158787) The demand for downsizing of electronic apparatus is also increasing.

However, in the electronic apparatus provided both with the electro-optic device and the sound generating member in the related art, it is necessary to secure a large surface area around the display unit of the electro-optic device for arranging the sound generating member. Therefore, the surface area around the display unit cannot be reduced, and hence a demand for downsizing is not sufficiently satisfied. In particular, the electronic apparatus provided with a plurality of sound generating members has a problem that a large surface area for arranging the sound generating members is required.

### SUMMARY

An advantage of some aspects of the invention is an electro-optic device in which the surface area around a display unit required for arranging a sound generating member may be reduced so that a demand for downsizing the electronic equipment can be sufficiently satisfied.

An advantage of another aspect of the invention is a compact electronic apparatus provided with the electro-optic device.

In order to achieve the above-described advantages, it is considered to reduce the surface area around the display unit required for arranging the sound generating members by reducing the size of the sound generating member. However, when the size of the sound generating member is reduced, the volume that the sound generating member generates may be insufficient, and hence the volume is reduced. In order to solve this problem, the inventor found that the problem is solved by arranging the speaker and the display unit so as to overlap with each other in plan view. In this case, the surface area around the display unit may be reduced while securing the size of the speaker sufficiently. However, in this case as well, it is necessary to secure a large surface area around the display unit in order to arrange a sound conducting channel or a sound releasing hole for outputting sounds generated by the speaker toward the outside. Therefore, the demand for downsizing is not sufficiently satisfied.

In order to achieve the above-described advantages, it is considered to reduce the size of the sound releasing hole. However, when the size of the sound releasing hole is reduced, the sound generated by the speaker is not released sufficiently. Therefore, even when the speaker has a performance to generate a sufficient volume, the volume generated by the sound generating member may be insufficient. Therefore, the size of the sound releasing hole cannot be reduced, and hence the surface area around the display unit cannot be reduced sufficiently.

In the device having one sound conducting channel for securing the opening surface area of the sound releasing hole, it is considered to provide a plurality of small sound releasing holes. However, since the sound releasing holes are openings of the sound conducting channel, they must be provided at positions in the area around the display unit which overlap with the sound conducting channels in plan view. Therefore, even when the plurality of small sized sound releasing holes are provided, there may be a case in which the respective sound releasing holes cannot be arranged adequately to reduce the surface area of the peripheral area, and hence the surface area around the display unit can not be reduced sufficiently.

After having devoted himself to study, the inventor found that the surface area around the display unit required for arranging the sound generating member may be reduced by arranging the speaker and the display area so as to overlap with each other in plan view and arranging the sound releasing holes provided for the respective plurality of sound generating member in a peripheral area along a part of the sides of the display area, and hence an electro-optic device and an electronic apparatus according to an aspect of the invention are provided.

An electro-optic device according to an aspect of the invention includes a display unit having a rectangular display area and a plurality of sound generating members, the plurality of sound generating members each include a speaker which is arranged so as to overlap the display area in plan view, and a sound releasing hole that outputs sounds generated by the speaker toward the outside, wherein the plurality of sound releasing holes which constitutes the plurality of sound generating members are arranged on the outside of the display area in plan view along part of the sides of the display area.

In the electro-optic device according to an aspect of the invention, since the plurality of sound generating members each include the speaker which is arranged so as to overlap the display area in plan view, the surface area of the peripheral area required for arranging the sound generating members may be reduced in comparison with the case in which the speakers are arranged so as not to overlap the display area in plan view.

In addition, in the electro-optic device according to an aspect of the invention, since the plurality of sound releasing holes which constitute the plurality of sound generating members are arranged in the peripheral area which is located on the outside of the display area in plan view along part of the sides of the display area, it is not necessary to secure the surface area for arranging the sound generating members in the peripheral area along three sides except for one side in case of a rectangular display area, whereby the surface area of the peripheral area required for arranging the sound generating members may be significantly reduced.

Preferably, the dimensions of the sound releasing hole are configured in such a manner that the dimension of the direction orthogonal to the direction extending along an outer edge of the display area is shorter than the dimension of the direction along the outer edge of the display area.

According to the electro-optic device in this configuration, when the surface areas of the sound releasing holes are the same, the surface area of the peripheral area required for arranging the sound releasing holes may be reduced in comparison with that having the dimensions such that the dimension of the direction orthogonal to the direction extending along an outer edge of the display area is longer than the dimension of the direction along the outer edge of the display area.

Preferably, the plurality of speakers which constitute the plurality of sound generating members are arranged in line so as not overlap with each other in plan view.

The electro-optic device in this configuration achieves a thin profile in comparison with that having the plurality of speakers arranged so as to overlap with each other in plan view.

Preferably, the plurality of speakers which constitute the plurality of sound generating members are arranged so as to overlap at least partly with each other in plan view.

The electro-optic device in this configuration achieves a further compact profile in comparison with that having the plurality of speakers arranged so as not to overlap with each other in plan view.

An electro-optic device according to an aspect of the invention includes a display unit having a display area and a sound generating member, wherein the sound generating member includes a speaker arranged so as to overlap the display area in plan view, an air chamber which comes in surface contact with the speaker, a plurality of sound releasing holes arranged in a peripheral area located on the outside of the display area in plan view, and a plurality of branched sound conducting channels each of which communicates each of the plurality of sound releasing holes and the air chamber.

In the electro-optic device according to an aspect of the invention, since the speaker is arranged so as to overlap the display area in plan view, the surface area of the peripheral area required for arranging the sound generating member may be reduced in comparison with the case in which the display area and the speaker do not overlap with each other in plan view.

In addition, in the electro-optic device according to an aspect of the invention, since there are provided the plurality of the sound releasing holes and the sound conducting channels which communicate with the sound releasing holes respectively, the size of the individual sound releasing holes may be reduced while securing the opening surface areas of the sound releasing holes. Since the sound generating member includes the plurality of sound releasing holes arranged in the peripheral area and the plurality of branched sound conducting channels each of which communicates each of the plurality of sound releasing holes and the air chamber, the respective sound releasing holes and the branched portion of the sound conducting channels which communicate with each of the sound releasing holes may be regarded as one set, and hence the one set may be arranged adequately so as to reduce the surface area of the peripheral area. Therefore, the arrangement of the respective sound releasing holes is not determined by the arrangement of the sound conducting channels, and hence the sound releasing holes may be arranged adequately, so that the surface area of the peripheral area may be significantly reduced.

Preferably, the plurality of sound releasing holes are arranged in a row along the outer edge of the display area.

With the electro-optic device in this configuration, the surface area of the peripheral area required for arranging the sound releasing holes and the sound conducting channels may be reduced further effectively.

Preferably, the display area has a rectangular shape and all the plurality of sound releasing holes are arranged along one side of the rectangle.

According to the electro-optic device in this configuration, since all the plurality of sound releasing holes are arranged along the one side of the rectangle, the surface area of the peripheral area required for arranging the sound releasing holes and the sound conducting channels may be reduced in comparison with the case in which the plurality of the sound releasing holes are arranged along the two or more sides of the rectangle.

Preferably, the plurality of sound generating members may be provided.

With the electro-optic device in this configuration, the sound generating member which can generate a plurality of sounds simultaneously and hence provide quality sounds is provided.

Preferably, the plurality of speakers which constitute the plurality of sound generating members are arranged so as not to overlap with each other in pan view.

The electro-optic device in this configuration achieves a thin profile in comparison with that including the plurality of speakers arranged so as to overlap with each other in plan view.

Preferably, the plurality of speakers which constitute the plurality of sound generating members may be arranged so as to overlap partly with each other in plan view.

The electro-optic device in this configuration may achieve a further compact profile in comparison with that including the plurality of speakers arranged so as not to overlap with each other in plan view.

Preferably, the display area has a rectangular shape, the plurality of sound generating members are divided into a first group and a second group, the plurality of sound releasing holes of the sound generating members which constitute the first group are all arranged along one side of the rectangle, and the plurality of sound releasing holes of the sound generating members which constitute the second group are all arranged along the side opposing one side of the rectangle.

With the electro-optic device in this configuration with the provision of the sound generating members which generates a plurality of sounds simultaneously, a sufficient distance may be secured between the sound releasing holes of the first group and the sound releasing holes of the second group. Therefore, and hence the sound generating member which has a high effect stereo sound and is superior in sound quality is provided.

In addition, since the plurality of sound releasing holes are arranged along the two opposed sides of the rectangle, the surface area of the peripheral area required for arranging the sound releasing holes and the sound conducting channels may be effectively reduced in comparison with the case in which the plurality of sound releasing holes are arranged along the three or more sides of the rectangle.

Preferably, the dimensions of the sound releasing hole are configured in such a manner that the dimension of the direction orthogonal to the direction extending along an outer edge of the display area is shorter than the dimension of the direction along the outer edge of the display area.

According to the electro-optic device in this configuration, when the surface areas of the sound releasing holes are the same, the surface area of the peripheral area required for arranging the sound releasing holes may be reduced in comparison with that having the dimensions such that the dimension of the direction orthogonal to the direction extending along an outer edge of the display area is longer than the dimension of the direction along the outer edge of the display area.

An electronic apparatus according to an aspect of the invention includes any one of electro-optic devices described above.

With the electronic apparatus configured as described above, a compact electronic apparatus is realized.

### BRIEF DESCRIPTION OF THE DRAWINGS

The invention will be described with reference to the accompanying drawings, wherein like numbers reference like elements.

FIG. 1A is an explanatory drawing showing an example of the electro-optic device according to an aspect of the invention and illustrates a structure in plan view.

FIG. 1B is a cross-sectional view of FIG. 1A taken along a line 1B-1B.

FIG. 1C is a partly enlarged drawing of FIG. 1A showing a part of the electro-optic device in an enlarged scale.

FIG. 2 is an explanatory drawing showing an example of the electro-optic device according to an aspect of the invention.

FIG. 3A is an explanatory drawing showing another example of the electro optic device according to an aspect of the invention, and illustrates a structure in plan view.

FIG. 3B is a cross-sectional view of FIG. 3A taken along the line IIIA-IIIA.

FIG. 3C is a cross-sectional view of FIG. 3A taken along the line IIIC-IIIC.

FIG. 4A is an explanatory drawing showing another example of the electro-optic device according to an aspect of the invention, and illustrates a structure in plan view.

FIG. 4B is a cross-sectional view of FIG. 4A taken along the line IVB-IVB.

FIG. 4C is a cross-sectional view of FIG. 4A taken along the line IVC-IVC.

FIG. 4D is a cross-sectional view of FIG. 4A taken along the line IVD-IVD.

FIG. 5A illustrates an example of the electro-optic device having two sound generating members and shows a structure in plan view.

FIG. 5B is a cross-sectional view of FIG. 5A taken along the line VB-VB.

FIG. 6A illustrates an example of the electro-optic device having two sound generating members and shows a structure in plan view.

FIG. 6B is a cross-sectional view of FIG. 6A taken along the line VIB-VIB.

FIG. 7A is an explanatory drawing showing an example of the electro-optic device according to an aspect of the invention and illustrates a structure in plan view.

FIG. 7B is a cross-sectional view of FIG. 7A taken along a line VIIB-VIIB.

FIG. 7C is a cross-sectional view of FIG. 7A taken along a line VIIC-VIIC.

FIG. 7D is an enlarged drawing showing a part of the electro-optic device in an enlarged scale.

FIG. 8 is an explanatory drawing showing another example of the electro-optic device according to an aspect of the invention.

FIG. 9A an explanatory drawing showing another example of the electro-optic device according to an aspect of the invention, and illustrates a structure in plan view.

FIG. 9B is a cross-sectional view of FIG. 9A taken along the line IXB-IXB.

FIG. 9C is a cross-sectional view of FIG. 9A taken along the line IXC-IXC.

FIG. 10A is an explanatory drawing showing another example of the electro-optic device according to an aspect of the invention, and illustrates a structure in plan view.

FIG. 10B is a cross-sectional view of FIG. 10A taken along the line XB, XIB-XB, XIB.

FIG. 10C is a cross-sectional view of FIG. 10A taken along the line XC, XIC-XC, XIC.

FIG. 10D is a cross-sectional view of FIG. 10A taken along the line XD-XD.

FIG. 11A is an explanatory drawing showing another example of the electro-optic device according to an aspect of the invention, and corresponds to the cross-sectional view taken along the line XB, XIB-XB, XIB in the plane structure of the electro-optic device shown in FIG. 10A.

FIG. 11B is a cross-sectional view of FIG. 10A taken along the line XC, XIC-XC, XIC.

FIG. 12A is an explanatory drawing showing another example of the electro-optic device according to an aspect of the invention, and illustrates a structure in plan view.

FIG. 12B is a cross-sectional view of FIG. 12A taken along the line XIIB-XIIE.

FIG. 12C is a cross-sectional view of FIG. 12A taken along the line XIIC-XIIC.

FIG. 12D is a cross-sectional view of FIG. 12A taken along the line XIID-XIID.

FIG. 13A illustrate an example of the electro-optic device provided with the two sound generating members each having one sound releasing hole, and shows a structure in plan view.

FIG. 13B is a cross-sectional view of FIG. 13A taken along the line XIIIB-XIIIB.

FIG. 13C is a cross-sectional view of FIG. 13A taken along the line XIIIC-XIIIC.

FIG. 14A illustrates an example of the electro-optic device having two sound generating members each having one sound releasing hole and shows a structure in plan view.

FIG. 14B is a cross-sectional view of FIG. 14A taken along the line XIVB-XIVB.

FIG. 14C is a cross-sectional view of FIG. 14A taken along the line XIVC-XIVC.

FIG. 15 is a perspective view showing a mobile phone as an example of the electronic apparatus according to an aspect of the invention.

### DESCRIPTION OF EXEMPLARY EMBODIMENTS

### First Embodiment of Electro-Optic Device

Referring now to the drawings, an embodiment of the invention will be described below. In the drawings used in the description shown below, contraction scale is differentiated for the respective layers and the respective members in order to present the respective layers and the respective members in recognizable scales in the drawings.

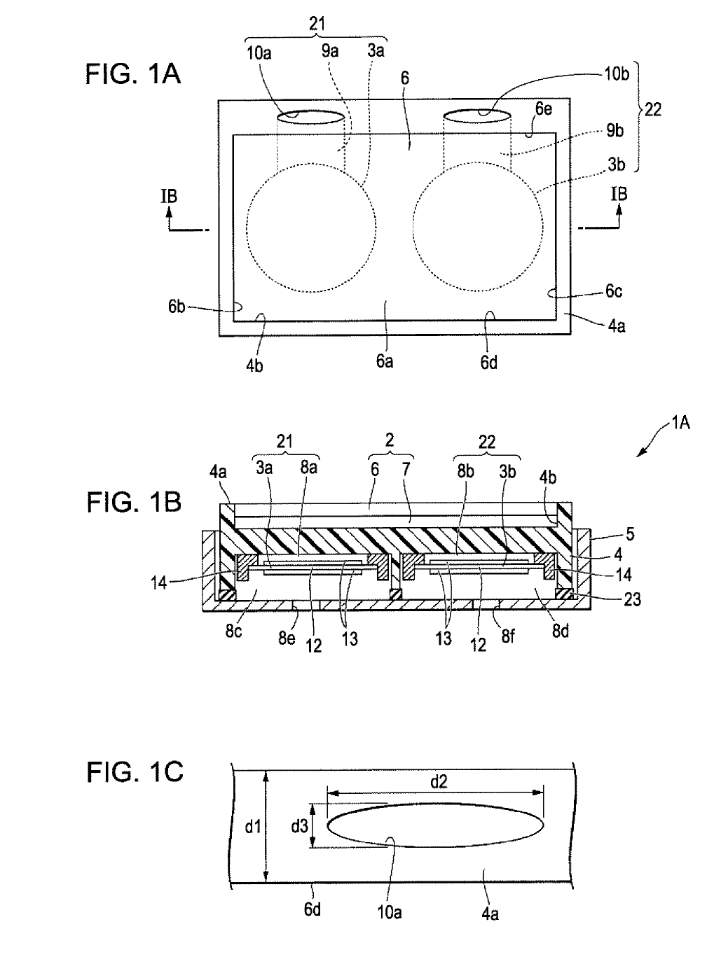

FIGS. 1A to 1C are explanatory drawings showing an example of the electro-optic device according to an aspect of the invention. FIG. 1A illustrates a structure in plan view, FIG. 1B is a cross-sectional view of FIG. 1A taken along a line IB-IB, and FIG. 1C is an enlarged drawing showing a part of the electro-optic device in an enlarged scale.

An electro-optic device 1A shown in FIGS. 1A to 1C includes a liquid crystal display device (display unit) 2 provided with a display area 6a, a sound generating member including a first sound generating member 21 and a second sound generating member 22, a frame 4, and a holding frame 5. The first sound generating member 21 and the second sound generating member 22 include speakers 3a and 3b, first air chambers (air chamber) 8a and 8b, sound releasing holes 10a and 10b, and sound conducting channels 9a and 9b, respectively.

In this embodiment, an example having two sound generating members, that is, the first sound generating member 21 and the second sound generating member 22 will be described. However, the number of sound generating member may be three or more.

The display area 6a of the liquid crystal display device 2 has a rectangular shape as shown in FIG. 1A, and the speakers 3a and 3b of the first sound generating member 21 and the second sound generating member 22 are arranged in the longitudinal direction of the display area 6a so as not to be overlapped with each other in plan view. The speakers 3a and 3b are overlapped with the display area 6a in plan view as shown in FIG. 1A.

The frame 4 is formed of, for example, resin, and is formed substantially into a quadratic prism or a square plate in appearance. One of the surfaces of the frame 4 (the lower surface in FIG. 1B) is formed with a first air chambers 3a and 3b formed of two recesses of a circular shape in plan view. The first air chambers 8a and 8b are spaces that come into surface contact with the speakers 3a and 3b, and are provided independently corresponding to the respective speakers 3a and 3b. The first air chambers 8a and 8b are formed in the frame 4 as spaces of a column shape or a disk shape and are formed on the side of the display area 6a with respect to the speakers 3a and 3b.

The speakers 3a and 3b generate sounds and, as shown in FIG. 1B, each include a ring-shaped supporting frame 14 formed of, for example, aluminum (Al), a disk-shaped oscillator 12 integrated with the supporting frame 14, and disk-shaped piezoelectric elements 13 secured to both surfaces of the oscillator 12. The speakers 3a and 3b, as shown in FIG. 1B, are supported by the frame 4 by the supporting frame 14 being secured to the lower surface of the frame 4 by means of bonding or other securing methods.

The two sound releasing holes 10a and 10b which constitute the first sound generating member 21 and the second sound generating member 22 are arranged in a peripheral area 4a located on the outside of the display area 6a in plan view as shown in FIG. 1A. More specifically, the two sound releasing holes 10a and 10b are arranged along a long side 6e, which is one side of a rectangle which constitutes an outer edge 6d of the display area 6a. The two sound releasing holes 10a and 10b are provided at positions where the length of the sound conducting channels 9a and 9b, described later, may be minimized for achieving the sound generating members which provide sounds in good quality.

FIG. 1C is an enlarged view showing only the sound releasing hole 10a out of the two sound releasing holes 10a and 10b. As shown in FIG. 1C, the dimensions of the sound releasing hole 10a is such that a width d3 in the direction orthogonal to the outer edge 6d of the display area 6a is shorter than a width d2 in the direction along the outer edge 6d of the display area 6a. With the shape of the sound releasing hole 10a as shown in FIG. 1C, the surface area of the peripheral area 4a is effectively reduced.

The sound releasing hole 10a is arranged so that the center of a width d1 of the peripheral area 4a substantially matches the center of the width d3 of the sound releasing hole 10a in the direction orthogonal to the direction along the outer edge 6d of the sound releasing hole 10a. With the arrangement such that the center of the width d1 of the peripheral area 4a matches the center of the width d3 of the sound releasing hole 10a, when the surface area of the peripheral area 4a is reduced, the strength of the peripheral portion of the sound releasing hole 10a is easily secured.

The frame 4 is formed with the two sound conducting channels 9a and 9b which constitute the first sound generating member 21 and the second sound generating member 22. The sound conducting channels 9a and 9b are provided so as to communicate the sound releasing holes 10a and 10b and the first air chambers 8a and 8b respectively.

The holding frame 5 is formed of metal such as aluminum or stainless steel, and is formed into a shape like a square pipe having a rectangular shape in plan view. As shown in FIG. 1B, the frame 4 is placed on the inner surface of the holding frame 5 via shock absorbing members 23. The shock absorbing members 23 are formed of resilient material such as resin or rubber. Spaces between the holding frame 5 and the speakers 3a and 3b serve as the second air chambers 8c and 8d. Part of the holding frame 5 which constitute the second air chambers 8c and 8d is provided with air-ventilation holes 8e and 8f.

In the first sound generating member 21 and the second sound generating member 22 shown in FIGS. 1A and 1B, when voice signal is transmitted to the piezoelectric elements 13 via a conductive line (not shown), the piezoelectric elements 13 oscillate the oscillator 12. Then, a sound which corresponds to the voice signal is generated by a mutual action between the oscillation of the oscillator 12 and the first air chambers 8a and 8b and the second air chambers 8c and 8d, which is outputted to the outside from the sound releasing holes 10a and 10b through the sound conducting channels 9a and 9b.

A recess 4b having a rectangular shape in plan view is provided at a center of the other surface of the frame 4 (the upper surface in FIG. 1B). Stored in the recess 4b of the frame 4 is, as shown in FIG. 1B, a liquid crystal display device 2 including a liquid crystal panel 6 as an electro-optic panel and an illumination device 7 provided on the liquid crystal panel 6. The liquid crystal display device 2 displays various types of information such as characters, numbers, or patterns as images in the display area 6a of the liquid crystal panel 6. In this embodiment, the area on the outside of the recess 4b of the frame 4 in plan view corresponds to the peripheral area 4a.

The illumination device 7 is arranged on the side of the frame 4 (lower side) of the liquid crystal panel 6, and serves as a backlight. The illumination device 7 may be configured to function as a front light by arranging on the observing side of the liquid crystal panel 6. The illumination device 7 may be configured, for example with a plurality of LEDs (Light Emitting Diodes) as light sources and a light guide. In the illumination device 7 of this type, light rays emitted from the LEDs are converted into a surface light by the light guide and supplied to the liquid crystal panel 6. The light sources may be a point light source other than the LED, or a linear light source such as a cold-cathode tube.

As the liquid crystal panel 6, for example, a liquid crystal panel formed by sealing liquid crystal between a pair of light-transmissive substrates each having an electrode may be employed. Polarized plates each having a polarization axis shifted as needed are provided respectively on the outer surfaces of the pair of light-transmissive substrates. When the surface light is supplied from the illumination device 7 to the liquid crystal panel 6, the light passing through the liquid crystal is modulated in each pixel by controlling the voltage to be applied to the pair of electrodes independently in each pixel, and the images such as characters, numbers or patterns are displayed on the light-exit side of the polarizing plate by allowing the modulated light to pass through the polarizing plate.

The liquid crystal panel 6 may be configured with arbitrary display modes. For example, the liquid crystal driving system may either be a simple matrix system or an active matrix system. The type of the liquid crystal mode may be, for example, TN (Twisted Nematic), STN (Super Twisted Nematic). The lighting system may be any one of transmissive, reflective, and transflective types. In this embodiment, the illumination device 7 is employed, and hence the lighting system is of the transmissive or the transflective type.

According to the electro-optic device 1A in this embodiment, the first sound generating member 21 and the second sound generating member 22 have the speakers 3a and 3b arranged so as to overlap the display area 6a in plan view. Therefore, the surface area of the peripheral area 4a required for arranging the first sound generating member 21 and the second sound generating member 22 can be reduced in comparison with the case in which the display area 6a and the speakers 3a and 3b are arranged so as not to be overlapped with each other in plan view.

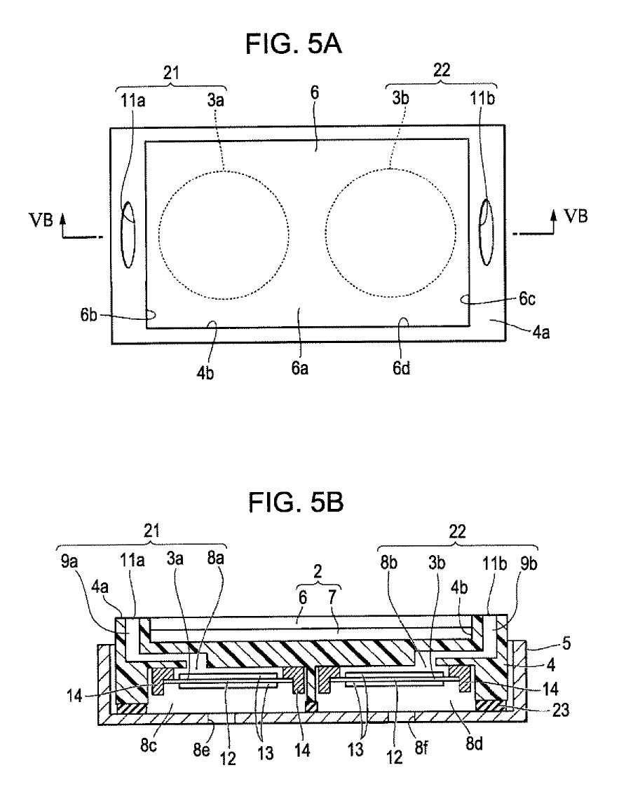

Referring now to FIGS. 5A and 5B, effects of some aspects of the invention will be described. FIGS. 5A and 5B illustrates an example of the electro-optic device having two sound generating members. FIG. 5A illustrates a structure in plan view, and FIG. 5B is a cross-sectional view of FIG. 5A taken along the line VB-VB. In the electro-optic device shown in FIGS. 5A and 5B, same parts as in the electro-optic device shown in FIGS. 1A to 1C are represented by same reference numerals and the description will not be made again.

A different point of the electro-optic device shown in FIGS. 5A and 5B from the electro-optic device 1A in FIGS. 1A to 1C is only the arrangement of the sound releasing holes. In the case of the electro-optic device shown in FIGS. 5A and 5B, as shown in FIG. 5A, a sound releasing hole 11a of the first sound generating member 21 is arranged near the center of a short side 6b of the rectangle, which corresponds to the outer edge 6d of the display area 6a and a sound releasing hole 11b of the second sound generating member 22 is arrange near the center of a short side 6c opposing the short side 6b of the rectangle.

Since the electro-optic device shown in FIGS. 5A and 5B is provided with the sound releasing holes 11a and 11b on the opposed short sides 6b and 6c, respectively, it is necessary to secure the surface areas for arranging the sound releasing holes 11a and 11b on the peripheral areas 4a along the two sides on side of the short side 6b and the side of the short side 6c. Therefore, the surface area of the peripheral area 4a along the two sides on the sides of the short sides 6b and 6c cannot be reduced sufficiently in comparison with the peripheral areas 4a along the two sides on the side of the long sides.

In contrast, in the case of the electro-optic device 1A shown in FIGS. 1A to 1C, since the two sound releasing holes 10a and 10b which constitute the first sound generating member 21 and the second sound generating member 22 are arranged on the peripheral area 4a along the long side 6e which is a side of the display area 6a of the rectangle, it is not necessary to secure the surface area in the peripheral area 4a along the three sides except for the long side 6e for arranging the first sound generating member 21 and the second sound generating member 22, and hence the surface area of the peripheral area 4a required for arranging the first sound generating member 21 and the second sound generating member 22 may be extremely reduced.

According to the electro-optic device 1A in this embodiment, since the speakers 3a and 3b are arranged so as not to be overlapped with respect to each other in plan view, a thinner electro-optic device is achieved in comparison with the case in which the speakers 3a and 3b are arranged so as overlap with each other.

In addition, according to the electro-optic device 1A in this embodiment, since the speakers 3a and 3b are arranged so as not to be overlapped with each other in plan view, the length of the sound conducting channels 9a and 9b may be equalized in both the first sound generating member 21 and the second sound generating member 22, and the phase of the sound outputted from the sound releasing holes 10a and 10b may be equalized, whereby a well balanced sound, which is ear friendly for the viewer, is advantageously achieved.

According to the electro-optic device 1A in this embodiment, since the sound releasing holes 10a and 10b are provided on the same surface as the display area 6a, the sound is ear friendly to the viewer viewing the display.

In the electro-optic device 1A in this embodiment, the two sound releasing holes 10a and 10b are arranged in the peripheral area 4a along the long side 6e which is one side of the rectangular display area 6a. However, it is also possible to arrange the two sound releasing holes 10a and 10b in the peripheral area 4a along the short side 6b or the short side 6c which is one side of the rectangular display area 6a. Preferably, the two sound releasing holes 10a and 10b are arranged so as to match the lateral direction of the image displayed in the liquid crystal display device 2. With the arrangement of the two sound releasing holes 10a and 10b so as to match the lateral direction of the image displayed in the liquid crystal display device 2, the sound is ear friendly to the viewer viewing the display.

When the two sound releasing holes 10a and 10b are arranged in the peripheral area 4a along the long side 6e which is one side of the rectangular display area 6a, the distance between the two sound releasing holes 10a and 10b may be increased in comparison with the case in which the two sound releasing holes 10a and 10b are arranged in the peripheral area 4a along the short side 6b or the short side 6c, which is one side of the rectangular display area 6a. Therefore, the sound generating member which has a high effect stereo sound and is superior in sound quality is provided.

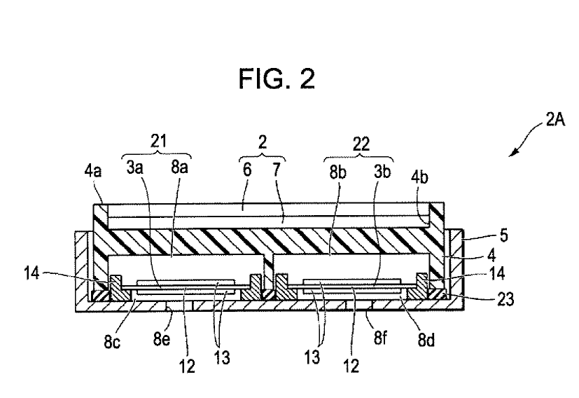

According to the electro-optic device 1A in this embodiment, an example in which the speakers 3a and 3b are supported by the frame 4 by the supporting frame 14 being secured to the lower surface of the frame 4 has been described. However, the invention is not limited to the above-describe embodiment and, for example, the speakers 3a and 3b may be supported by the holding frame 5 by the supporting frame 14 being secured to the inner surface of the holding frame 5 via the shock absorbing members 23 as in the case of an electro-optic device 2A shown in FIG. 2. FIG. 2 is an explanatory drawing showing another example of the electro-optic device according to an aspect of the invention, and corresponds to the cross-sectional view taken along the line IIB-IIB in the plane structure of the electro-optic device shown in FIG. 1A.

### Second Embodiment of Electro-Optic Device

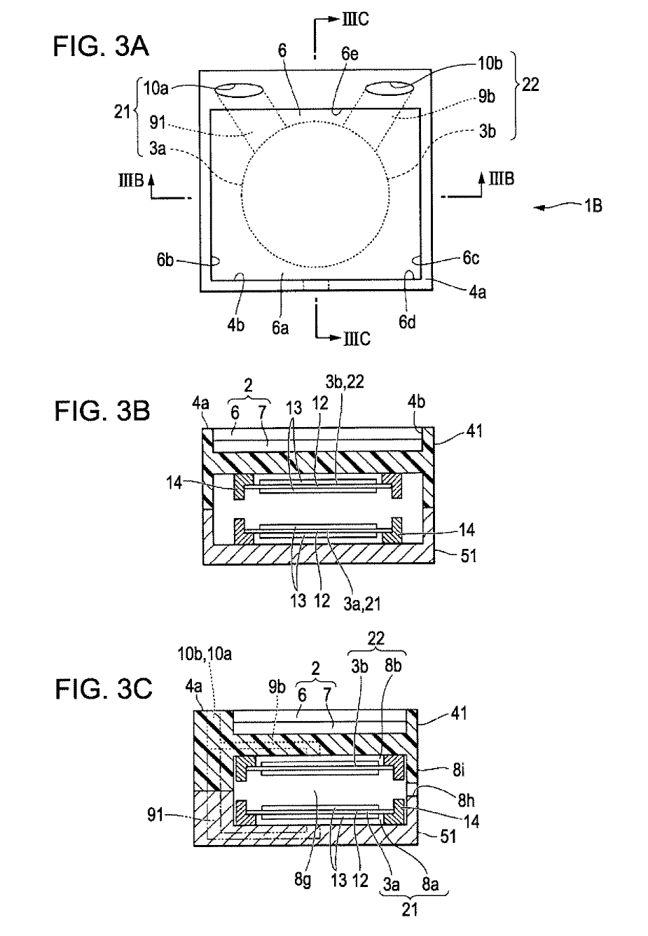

FIGS. 3A to 3C are explanatory drawings showing another example of the electro-optic device according to an aspect of the invention. FIG. 3A illustrates a structure in plan view, FIG. 3B is a cross-sectional view of FIG. 3A taken along the line IIIB-IIIB and FIG. 3C is a cross-sectional view of FIG. 3A taken along the line IIIC-IIIC. In the electro-optic device shown in FIGS. 3A to 3C, same parts as in the electro-optic device shown in FIGS. 1A to 1C are represented by same reference numerals and the description will not be made again.

As shown in FIG. 3A, an electro-optic device 1B in this embodiment has the display area 6a of the liquid crystal display device 2 which has a rectangular shape whose difference of length between the long side and the short side is smaller than the electro-optic device 1A shown in FIGS. 1A to 1C. As shown in FIGS. 3A and 3I, the speakers 3a and 3b are arranged so as to overlap with each other in plan view. The speakers 3a and 3b are overlapped with the display area 6a in plan view like the electro-optic device 1A shown in FIGS. 1A to 1C.

According to the electro-optic device 1A shown in FIGS. 1A to 1C, the speakers 3a and 3b are supported by the frame 4. However, according to the electro-optic device 1B shown in FIGS. 3A to 3C, the speaker 3a is supported by a holding frame 51. A space of column shape or a disk shape formed on the side of the holding frame 51 with respect to the speaker 3a (lower side in FIGS. 3A to 3C) which corresponds to a space between the speaker 3a and the inner wall of the holding frame 51 functions as the first air chamber 8a. A space between the speaker 3a and the speaker 3b functions as a second air chamber 8g which is shared by the first sound generating member 21 and the second sound generating member 22. Furthermore, according to the electro-optic device 1B shown in FIGS. 3A to 3C, the side surface 8i is formed by a frame 41 and the holding frame 51 bonded to each other, and an air-ventilation hole 8h is provided on a part of the side surface 8i as shown in FIG. 3B.

According to the electro-optic device 1B in this embodiment, a sound conducting channel 91 of the first sound generating member 21 is formed in the frame 41 and the holding frame 51 as shown in FIG. 3B. The sound conducting channel 91 is provided so as to communicate the sound releasing hole 10a and the first air chamber 8a as shown in FIGS. 3A and 3C.

According to the electro-optic device 1B in this embodiment, the sound conducting channel 91 and 9b are formed so as to extend from the center of the display area 6a in the inclined direction with respect to the long side 6e thereof and in the direction apart from each other in plan view, and the two sound releasing holes 10a and 10b are arranged in line so as not to be overlapped with respect to each other in plan view as shown in FIG. 3A.

According to the electro-optic device 1B in this embodiment, since the speakers 3a and 3b are arranged so as to overlap with each other in plan view, it is difficult to form the sound conducting channels 91 and 9b for the first sound generating member 21 and the second sound generating member 22 in the same length. Therefore, according to the electro-optic device 1B in this embodiment, it is preferable to differentiate the cross-sectional areas of the sound conducting channel 91 and the sound conducting channel 9b significantly to compensate the difference in sound quality caused by the difference in length between the sound conducting channels 91 and 9b and equalize the phase of the sounds generated from the sound releasing holes 10a and 10b More specifically, the difference in sound quality caused by the difference in length of the sound conducting channels 91, 9b are adequately compensated by a method of increasing the cross-sectional area of the sound conducting channel 91, which is the longer one, or a method of reducing the cross-sectional area of the sound conducting channel 9b, which is the shorter one, whereby a well balanced sound, which is ear friendly for the viewer, is advantageously achieved.

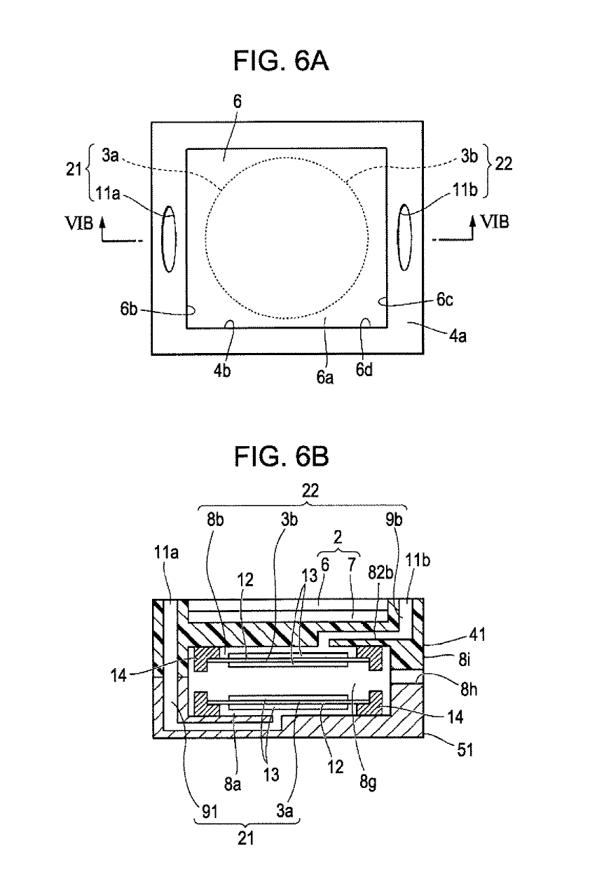

Referring now to FIGS. 6A and 6B, effects of some aspects of the invention will be described. FIGS. 6A and 6B illustrate an example of the electro-optic device having two sound generating members. FIG. 6A illustrates a structure in plan view, and FIG. 6B is a cross-sectional view of FIG. 6A taken along the line VIB-VIB. In the electro-optic device shown in FIGS. 6A and 6B, same parts as in the electro-optic device shown in FIGS. 3A to 3C are represented by same reference numerals and the description will not be made again.

A different point of the electro-optic device shown in FIGS. 6A and 6B from the electro-optic device 1B in FIGS. 3A to 3C is only the sound releasing holes. According to the electro-optic device shown in FIGS. 6A and 6B, as shown in FIG. 6A, the sound releasing hole 11a of the first sound generating member 21 is arranged near the center of the short side 6b of the rectangular shape, which corresponds to the outer edge 6d of the display area 6a, and the sound releasing hole 11b of the second sound generating member 22 is arranged near the center of the short side 6c opposing the short side 6b of the rectangular shape.

Like the electro-optic device shown in FIGS. 5A and 5B, according to the electro-optic device shown in FIGS. 6A and 6B, it is necessary to secure a surface area for arranging the sound releasing holes 11a and 11b in the peripheral area 4a along the two sides on the side of the short side 6b and the side of the short side 6c. Therefore, the surface area of the peripheral area 4a along the two sides on the side of the short sides 6b and 6c cannot be reduced sufficiently in comparison with the peripheral area 4a along the two sides on the side of the long sides.

In contrast, according to the electro-optic device 1B shown in FIGS. 3A to 3C, since the two sound releasing holes 10a and 10b which constitute the first sound generating member 21 and the second sound generating member 22 are arranged in the peripheral area 4a along the long side 6e, which is one side of the rectangular display area 6a, it is not necessary to secure the surface area for arranging the first sound generating member 21 and the second sound generating member 22 in the peripheral area 4a along the three sides except for the long side 6e, whereby the surface area of the peripheral area 4a required for arranging the first sound generating member 21 and the second sound generating member 22 may be significantly reduced.

According to the electro-optic device 1B shown in FIGS. 3A to 3C, the display area 6a of the liquid crystal display device 2 has a rectangular shape whose difference of length between the long side 6e and the short sides 6b and 6c is smaller than the electro-optic device 1A shown in FIGS. 1A to 1C, and the speakers 3a and 3b are arranged so as to overlap with each other in plan view, and are arranged so as to overlap the display area 6a in plan view. Therefore, the size of the electro-optic device may further be reduced in comparison with the electro-optic device 1A shown in FIGS. 1A to 1C.

In addition, according to the electro-optic device 1B shown in FIGS. 3A to 3C, the space between the speaker 3a and the speaker 3b functions as the second air chamber 8g which is shared by the first sound generating member 21 and the second sound generating member 22. Therefore, the thickness of the electro-optic device may be reduced in comparison with the case in which independent second air chambers are provided in the first sound generating member 21 and the second sound generating member 22 respectively.

According to the electro-optic device 1A shown in FIGS. 1A to 1C, the dimensions of the two speakers 3a and 3b must be determined according to half a length of the long side of the display area 6a. However, according to the electro-optic device 1B shown in FIGS. 3A to 3C, the dimensions of the two speakers 3a and 3b may be determined according to the length of the short side of the display area 6a. Therefore, according to the electro-optic device 1b shown in FIGS. 3A to 3C, relatively larger speakers 3a and 3b with respect to the display area 6a may be provided in comparison with the electro-optic device 1A shown in FIGS. 1A to 1C, and hence the sound generating member which has a high effect stereo sound and is superior in sound quality is provided.

### Third Embodiment of Electro-Optic Device

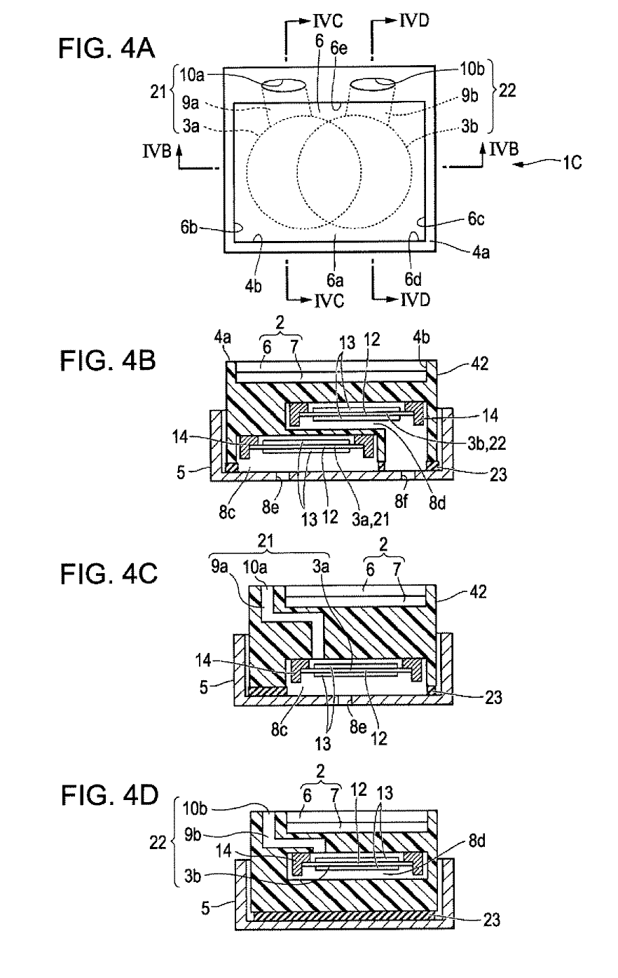

FIGS. 4A to 4D are explanatory drawings showing another example of the electro-optic device according to an aspect of the invention. FIG. 4A illustrates a structure in plan view, FIG. 4B is a cross-sectional view of FIG. 4A taken along the line IVB-IVB, FIG. 4C is a cross-sectional view of FIG. 4A taken along the line IVC-IVC, and FIG. 4D is a cross-sectional view of FIG. 4A taken along the line IVD-IVD. In the electro-optic device shown in FIGS. 4A to 4D, same parts as in the electro-optic device 1A shown in FIGS. 1A to 1C are represented by same reference numerals and the description will not be made again.

As shown in FIG. 4A, an electro-optic device 1C in this embodiment has the display area 6a of the liquid crystal display device 2 which has a rectangular shape whose difference in length between the long side 6e and the short sides 6b and 6c is smaller than the electro-optic device 1A shown in FIGS. 1A to 1C, whose difference in length between the long side 6e and the short sides 6b and 6c is larger than the electro-optic device 1B shown in FIGS. 3A to 3C. According to the electro-optic device 1C in this embodiment, the speakers 3a and 3b are arranged so as to be overlapped partly with each other in plan view as shown in FIGS. 4A and 4B. As shown in FIGS. 4A and 4B, the speakers 3a and 3b are overlapped with the display area 6a in plan view like the electro-optic device 1A shown in FIGS. 1A to 1C.

According to the electro-optic device 1C in this embodiment, as shown in FIGS. 4B, 4C and 4D, the interior of a frame 42 is formed into a stair shape. The speaker 3b of the second sound generating member 22 is provided on the step closer to the liquid crystal display device 2, and the speaker 3a of the first sound generating member 21 is provided on the step farther from the liquid crystal display device 2.

According to the electro-optic device 1C in this embodiment, the sound conducting channels 9a and 9b are formed so as to extend from the centers of the speakers 3a and 3b in the inclined direction with respect to the long side 6e thereof and in the direction apart from each other in plan view, and the two sound releasing holes 10a and 10b are arranged in line so as not to be overlapped with respect to each other in plan view as shown in FIG. 4A.

Like the electro-optic device 1A shown in FIGS. 1A to 1C, according to the electro-optic device 1C shown in FIGS. 4A to 4D, since the two sound releasing holes 10a and 10b constituting the first sound generating member 21 and the second sound generating member 22 are arranged in the peripheral area 4a along the long side 6e, which is one side of the rectangular display area 6a, it is not necessary to secure the surface area for arranging the first sound generating member 21 and the second sound generating member 22 in the peripheral area 4a along the three sides except for the long side 6e, whereby the surface area of the peripheral area 4a required for arranging the first sound generating member 21 and the second sound generating member 22 may be significantly reduced.

According to the electro-optic device 1C shown in FIGS. 4A to 4D, the display area 6a of the liquid crystal display device 2 has a rectangular shape whose difference of length between the long side 6e and the short sides 6b and 6c is smaller than the electro-optic device 1A shown in FIGS. 1A to 1C, and the speakers 3a and 3b are arranged so as to overlap partly with each other in plan view, and are arranged so as to overlap the display area 6a in plan view. Therefore, the size of the electro-optic device may further be reduced in comparison with the electro-optic device 1A shown in FIGS. 1A to 1C. Since the dimensions of the two speakers 3a and 3b may be determined according to the lengths of the short sides 6b and 6c of the display area 6a, relatively larger speakers 3a and 3b with respect to the display area 6a may be provided in comparison with the electro-optic device LA shown in FIGS. 1A to 1C.

The electro-optic device 1C shown in FIGS. 4A to 4D has the display area 6a has a rectangular shape whose difference in length between the long side 6e and the short sides 6b and 6c is larger in comparison with the electro-optic device 1B shown in FIGS. 3A to 3C. Therefore, in comparison with the electro-optic device 1B shown in FIGS. 3A to 3C, the distance between the two sound releasing holes 10a and 10b may be increased, and hence the sound generating member which has a high effect stereo sound and is superior in sound quality is provided.

### Fourth Embodiment of Electro-Optic Device

Referring now to the drawings, another embodiment of the invention will be described. In the drawings used in the description shown below, contraction scale is differentiated for the respective layers and the respective members in order to present the respective layers and the respective members in recognizable scales in the drawings.

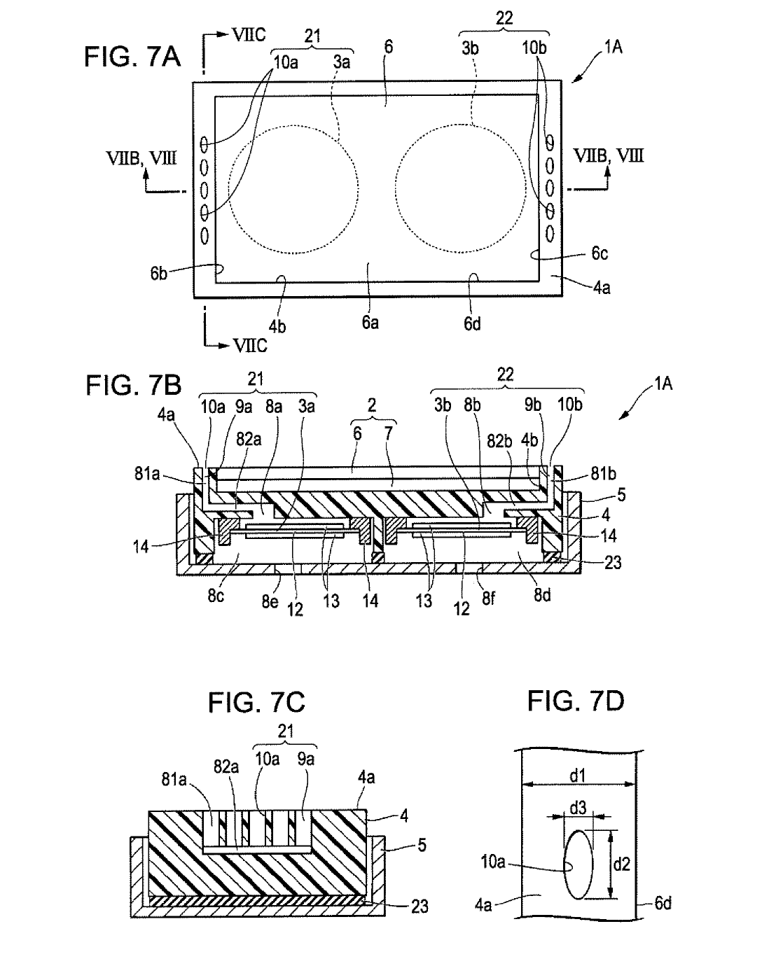

FIGS. 7A to 7D are explanatory drawings showing an example of the electro-optic device according to an aspect of the invention. FIG. 7A illustrates a structure in plan view, FIG. 7B is a cross-sectional view of FIG. 7A taken along a line VIIB-VIIB, FIG. 7C is a cross-sectional view of FIG. 7A taken along a line VIIC-VIIC, and FIG. 7D is an enlarged drawing showing a part of the electro-optic device in an enlarged scale.

The electro-optic device 1A shown in FIGS. 7A to 7C includes a liquid crystal display device (display unit) 2, a sound generating member including a first sound generating members (first group) 21 and a second sound generating members (second group) 22, a frame 4, and a holding frame 5. The first sound generating member 21 and the second sound generating member 22 include the speakers 3a and 3b, the first air chambers (air chamber) 8a and 8b, sound releasing holes 10a and 10b, and the sound conducting channels 9a and 9b, respectively, as shown in FIG. 75.

In this embodiment, an example having two sound generating members, that is, the first sound generating member 21 and the second sound generating member 22 will be described. However, the number of sound generating member may be one, or three or more, and is not limited specifically. In this embodiment, an example having a first group and a second group, each having one sound generating member will be described. However, the number of the sound generating members in the first group and the second group may be two or more, and is not limited specifically.

The display area 6a of the liquid crystal display device 2 has a rectangular shape as shown in FIG. 7A, and the speakers 3a and 3b of the first sound generating member 21 and the second sound generating member 22 are arranged in the longitudinal direction of the display area 6a so as not to be overlapped with each other in plan view. The speakers 3a and 3b are overlapped with the display area 6a in plan view as shown in FIG. 7A.

The frame 4 is formed of, for example, resin, and is formed substantially into a quadratic prism or a rectangular plate. One of the surfaces of the frame 4 (the lower surface in FIG. 7B) is formed with the first air chambers 8a and 8b formed of two recesses of a circular shape in plan view. The first air chambers 8a and 8b are spaces that come into surface contact with the speakers 3a and 3b, and are provided independently corresponding to the respective speakers 3a and 3b. The first air chambers 8a and 8b are formed in the frame 4 as spaces of a column shape or a disk shape and are formed on the side of the display area 6a with respect to the speakers 3a and 3b.

The speakers 3a and 3b generate sounds and, as shown in FIG. 7B, each include a ring-shaped supporting frame 14 formed of aluminum (Al), a disk-shaped oscillator 12 integrated with the supporting frame 14, and disk-shaped piezoelectric elements 13 secured to both surfaces of the oscillator 12. The speakers 3a and 3b are supported by the frame 4 by the supporting frame 14 being secured to the lower surface of the frame 4 by means of bonding or other securing methods, as shown in FIG. 7B.

The plurality of sound releasing holes 10a and 10b which constitute the first sound generating member 21 and the second sound generating member 22 are arranged in the peripheral area 4a located on the outside of the display area 6a in plan view as shown in FIG. 7A. More specifically, the plurality of sound releasing holes 10a of the first sound generating member 21 are all arranged in one row along the short side 6b of the rectangle, which corresponds to the outer edge 6d of the display area 6a. The plurality of sound releasing holes 10b of the second sound generating member 22 are all arranged along the short side 6c opposing the shot side b of the rectangle.

FIG. 7D is an enlarged view showing only the sound releasing hole 10a and the periphery thereof out of the plurality of sound releasing holes. As shown in FIG. 7D, the dimensions of the sound releasing hole 10a is such that the width d3 in the direction orthogonal to the outer edge 6d of the display area 6a is shorter than the width d2 in the direction along the outer edge 6d of the display area 6a. With the shape of the sound releasing hole 10a as shown in FIG. 7D, the surface area of the peripheral area 4a is effectively reduced.

The sound releasing hole 10a is arranged so that the center of the width d1 of the peripheral area 4a matches the center of the width d3 of the sound releasing hole 10a in the direction orthogonal to the direction along the outer edge 6d. With the arrangement such that the center of the width d1 of the peripheral area 4a substantially matches the center of the width d3 of the sound releasing hole 10a, when the surface area of the peripheral area 4a is reduced, the strength of the peripheral portion of the sound releasing hole 10a is easily secured.

The recess 4b having a rectangular shape in plan view is provided at a center of the other surface of the frame 4 (the upper surface in FIG. 7B). The area on the outside of the recess 4b of the frame 4 in plan view is the peripheral area 4a. As shown in FIG. 7C, the frame 4 which constitutes the peripheral area 4a is formed with the sound conducting channels 9a and 9b branched into a plurality of channels. The sound conducting channels 9a and 9b are provided so as to communicate the plurality of sound releasing holes 10a and 10b and the first air chambers 8a and 8b respectively as shown in FIG. 7B. The sound conducting channels 9a and 9b includes vertical channels 81a and 81b divided into the same number as the number of the sound releasing holes 10a and 10b and horizontal channels 82a and 82b corresponding to the respective first air chambers 8a and 8b and, and are branched into the same number as the number of sound releasing holes 10a and 10b from the branch points between the vertical channels 81a and 81b and the horizontal channels 82a and 82b as shown in FIGS. 7B and 7C.

The vertical channels 81a and 81b are provided by the same number as the sound releasing holes 10a and 10b in the direction orthogonal to the direction of extension of the display area 6a, and have the same shape as the sound releasing holes 10a and 10b in plan view. The vertical channels 81a and 81b are formed in the peripheral area 4a along the short sides 6b and 6c of the display area 6a as shown in FIGS. 7B and 7C, and are provided so as to communicate the plurality of sound releasing holes 10a and 10b and the horizontal channels 82a and 82b respectively.

The horizontal channels 82a and 82b are provided in the direction parallel with the direction of extension of the display area 6a. The horizontal channel 82a which constitutes the sound conducting channel 9a connects all the vertical channels 81a which communicate with the respective sound releasing holes 10a and the first air chamber 8a, and the horizontal channel 82b which constitute the sound conducting channel 9b connects all the vertical channel 81b which communicate with the respective sound releasing holes 10b and the first air chamber 8b.

In this embodiment, an example of the sound generating member having the sound conducting channels 9a and 9b provided with the horizontal channels 82a and 82b which connect all the vertical channels 81a and 81b which communicate with the respective sound releasing holes 10a and 10b and the first air chambers 8a and 8b has been described. However, the branch points of the sound conducting channels 9a and 9b do not have to be necessarily the connecting portions between the vertical channels 81a and 81b and the horizontal channels 82a and 82b, and may be located in the vertical channel or in the horizontal channel. Therefore, the horizontal channel of the sound conducting channel may be divided into the same number as the number of the sound releasing holes and are communicated independently with the respective vertical channels. In this embodiment, the example in which the sound conducting channels 9a and 9b provided with the vertical channels 81a and 81b divided into the same number as the number of the sound releasing holes 10a and 10b over the entire length has been described. However, the sound conducting channels 9a and 9b must simply be divided at least part of the vertical channel on the side of the sound releasing hole into the same number as the number of the sound releasing holes.

Here, in the sound conducting channels 9a and 9b, the longer the portion of the sound conducting channels 9a and 9b divided into the same number as the number of sound releasing holes 10a and 10b, the more the amount of material which constitute the frame 4 in the peripheral portion of the sound conducting channels 9a and 9b is needed, and hence the strength is enhanced. The longer the portion of the sound conducting channels 9a and 9b which is not divided, the higher the ratio of the portion of the sound conducting channel having a large surface area with respect to the entire lengths of the sound conducting channels 9a and 9b would be, and hence the preferable sound quality is achieved.

The holding frame 5 is formed of metal such as aluminum or stainless steel, and is formed into a shape like a square pipe having a rectangular shape in plan view. As shown in FIGS. 7B and 7C, the frame 4 is placed on the inner surface of the holding frame 5 via shock absorbing members 23. The shock absorbing members 23 are formed of resilient material such as resin or rubber. Spaces between the holding frame 5 and the speakers 3a and 3b serve as the second air chambers 8c and 8d. Parts of the holding frame 5 which constitute the second air chambers 8c and 8d is provided with air-ventilation holes 8e and 8f.

In the first sound generating member 21 and the second sound generating member 22 shown in FIGS. 7A, 7B and 7C, when voice signal is transmitted to the piezoelectric elements 13 via a conductive line (not shown), the piezoelectric elements 13 oscillate the oscillator 12. Then, a sound which corresponds to the voice signal is generated by a mutual action between the oscillation of the oscillator 12 and the first air chambers 8a and 8b and the second air chambers 8c and 8d, which is outputted to the outside from the sound releasing holes 10a and 10b through the horizontal channels 82a and 82b and the vertical channels 81a and 81b.

Stored in the recess 4b of the frame 4 is, as shown in FIG. 7B, a liquid crystal display device 2 including a liquid crystal panel 6 as an electro-optic panel and an illumination device 7 provided on the liquid crystal panel 6. The liquid crystal display device 2 displays various types of information such as characters, numbers, or patterns as images in the display area 6a of the liquid crystal panel 6.

The illumination device 7 is arranged on the side of the frame 4 (lower side) of the liquid crystal panel 6, and serves as a backlight. The illumination device 7 may be configured to function as a front light by arranging on the observing side of the liquid crystal panel 6. The illumination device 7 may be configured, for example with a plurality of LEDs (Light Emitting Diodes) as light sources and a light guide. In the illumination device 7 of this type, light rays emitted from the LEDs are converted into a surface light by the light guide and supplied to the liquid crystal panel 6. The light sources may be a point light source other than the LED, or a linear light source such as a cold-cathode tube.

As the liquid crystal panel 6, for example, a liquid crystal panel formed by sealing liquid crystal between a pair of light-transmissive substrates each having an electrode may be employed. Polarized plates each having a polarization axis shifted as needed is provided respectively on the outer surfaces of the pair of light-transmissive substrates. When the surface light is supplied from the illumination device 7 to the liquid crystal panel 6, the light passing through the liquid crystal is modulated in each pixel by controlling the voltage to be applied to the pair of electrodes independently in each pixel, and the images such as characters, numbers or patterns are displayed on the light-exit side of the polarizing plate by allowing the modulated light to pass through the polarizing plate.

The liquid crystal panel 6 may be configured with arbitrary display modes. For example, the liquid crystal driving system may either be a simple matrix system or an active matrix system. The type of the liquid crystal mode may be, for example, TN (Twisted Nematic), STN (Super Twisted Nematic). The lighting system may any one of transmissive, reflective, and transflective types. In this embodiment, the illumination device 7 is employed, and hence the lighting system is of the transmissive or the transflective type.

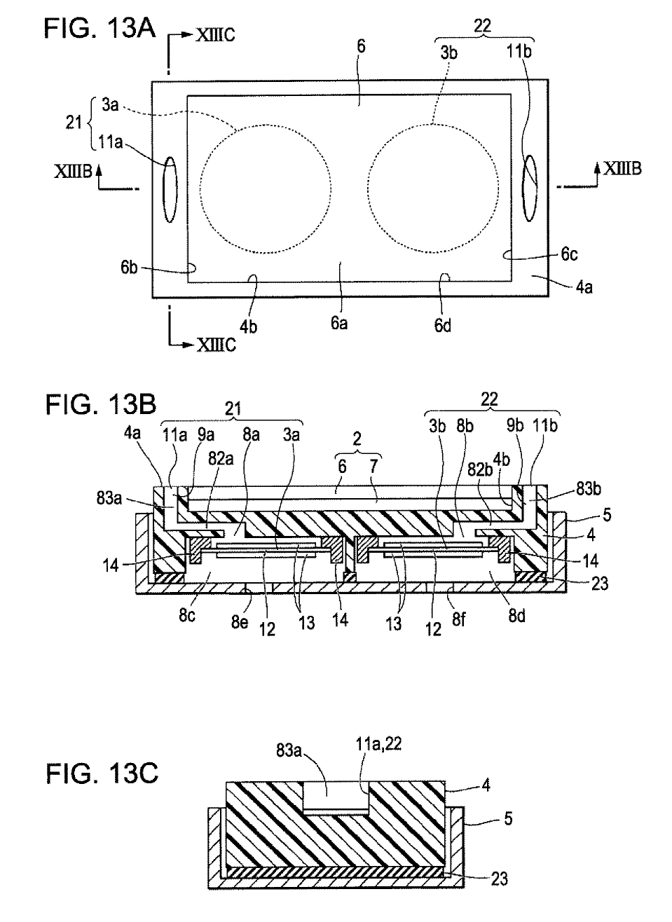

Referring now to FIGS. 13A to 13C, effects of some aspects of the invention will be described. FIGS. 13A to 13C illustrate an example of the electro-optic device provided with the two sound generating members each having one sound releasing hole. FIG. 13A illustrates a structure in plan view, FIG. 13B is a cross-sectional view of FIG. 13A taken along the line XIIIB-XIIIB, and FIG. 13C is a cross-sectional view of FIG. 13A taken along the line XIIIC-XIIIC. In the electro-optic device shown in FIGS. 13A to 13C, same parts as in the electro-optic device shown in FIGS. 7A to 7C are represented by same reference numerals and the description will not be made again.

A different point of the electro-optic device shown in FIGS. 13A to 13C from the electro-optic device 1A in FIGS. 1A to 1C is only the sound releasing holes and the vertical channels of the sound conducting channels.

According to the electro-optic device shown in FIGS. 13A to 13C, one each of the sound releasing holes 11a and 11b constitutes the first sound generating member 21 and the second sound generating member 22, as shown in FIG. 13A, and are arranged in the peripheral area 4a located outside the display area 6a in plan view. More specifically, the sound releasing hole 11a of the first sound generating member 21 is arranged near the center of the short side 6b of the rectangular shape, which corresponds to the outer edge 6d of the display area 6a, and the sound releasing hole 11b of the second sound generating member 22 is arranged near the center of the short side 6c opposing the short side 6b of the rectangular shape.

One each of the vertical channels 83a and 83b of the sound conducting channels 9a and 9b is provided in the direction orthogonal to the direction of extension of the display area 6a as shown in FIGS. 13B and 13C, having the same shape as the sound releasing holes 11a and 11b in plan view, and one each of the sound releasing holes 11a and 11b and the horizontal channels 82a and 82b are communicated thereby.

Since the electro-optic device shown in FIGS. 13A to 13C is provided with the sound generating member 21 and 22 including the sound conducting channels 9a and 9b having one each of the sound releasing holes 11a and 11b and one each of the vertical channels 83a and 83b respectively, one each of the sound releasing holes 11a and 11b and one each of the vertical channels 83a and 83b must secure predetermined opening areas. Therefore, the sound releasing holes 11a and 11b and the vertical channels 83a and 83b cannot be downsized, and hence the surface area of the peripheral area 4a required for arranging the sound releasing holes 11a and 11b and the vertical channels 83a and 83b cannot be reduced sufficiently.

According to the electro-optic device shown in FIGS. 13A to 13C, even when the plurality of small sound releasing holes 11a and 11b are provided, the arrangement of the sound releasing holes is determined by the arrangement of the vertical channels 83a and 83b. Therefore, the sound releasing holes cannot be arranged adequately so as to reduce the surface area of the peripheral area 4a.

According to the electro-optic device shown in FIGS. 13A to 13C, since the vertical channels 83a and 83b each constitute a thick and large void in the frame, the amount of material which constitutes the frame 4 is remarkably reduced only in the peripheral portions of the vertical channels 83a and 83b, and hence the variation in strength of the frame 4 increases. Therefore, the thickness of the frame 4 in the peripheral portions of the vertical channels 83a and 83b must be secured sufficiently.

Now, according to the electro-optic device shown in FIGS. 13A to 13C, it is considered to reduce the surface area of the peripheral area 4a required for arranging the sound releasing holes 11a and 11b by elongating the sound releasing holes 11a and 11b in the direction of the short sides 6b and 6c of the rectangle and reducing in width. However, in this case as well, since the vertical channels 83a and 83b each constitute a large void elongated in the direction of the short sides 6b and 6c of the rectangular shape in the frame 4, the strength of the frame 4 is insufficient.

In contrast, the electro-optic device 1A shown in FIGS. 7A, 7B and 7C, since a plurality of the sound releasing holes 10a and 10b, and the vertical channels 81a and 81b of the sound conducting channels 9a and 9b which communicate with the sound releasing holes 10a and 10b are provided, the sizes of the respective sound releasing holes 10a and 10b may be reduced while securing sufficient opening surface areas of the sound releasing holes 10a and 10b.

Since the first sound generating member 21 and the second sound generating member 22 each includes the plurality of the sound releasing holes 10a and 10b arranged in the peripheral area 4a and the sound conducting channels 9a and 9b provided with the plurality of vertical channels 81a and 81b which communicates the plurality of sound releasing holes 10a and 10b and the first air chambers 8a and 8b respectively, each of the sound releasing holes 10a and 10b and each of the vertical channels 81a and 81b communicating with the respective sound releasing holes 10a and 10b may be regarded as one set, and hence the one set may be arranged adequately so as to reduce the surface area of the peripheral area 4a. Therefore, the arrangement of the respective sound releasing holes 10a and 10b is not determined by the arrangement of the sound conducting channels 9a and 9b, and hence the respective sound releasing holes 10a and 10b and the vertical channels 81a and 81b may be arranged adequately so as to reduce the surface area of the peripheral area 4a, so that the surface area of the peripheral area 4a required for arranging the sound releasing holes 10a and 10b and the sound conducting channels 9a and 9b may be significantly reduced.

According to the electro-optic device 1A shown in FIGS. 7A to 7C, the vertical channels 81a and 81b constitute a plurality of thin and small void partitioned from each other in the frame 4, and hence the peripheral portions of the vertical channels are reinforced by the material of the frame 4 which constitutes the partitions. Therefore, according to the electro-optic device 1A shown in FIGS. 7A to 7, the amount of material which constitutes the frame 4 in the peripheries of the vertical channels increases and variations in intensity of the frame 4 is reduced in comparison with the electro-optic device shown in FIGS. 13A to 13C. Consequently, the thickness of the frame in the peripheries of the vertical channels 81a and 81b may be reduced sufficiently.

In this manner, according to the electro-optic device 1A in this embodiment, the surface area of the peripheral area required for arranging the sound releasing holes 10a and 10b and the vertical channels 81a and 81b may be reduced.

According to the electro-optic device 1A in this embodiment, since the speakers 3a and 3b are overlapped with the display area 6a in plan view, the electro-optic device 1A may be downsized in comparison with the case in which the speakers 3a and 3b are arranged in the peripheral area 4a.

According to the electro-optic device 1A in this embodiment, since the sound releasing holes 10a and 10b are provided on the same surface as the display area 6a, the sound is ear friendly to the viewer viewing the display.

According to the electro-optic device 1A in this embodiment, since the speakers 3a and 3b are arranged in line so as not to be overlapped with each other in plan view, the thinner electro-optic device is achieved in comparison with the case in which the speakers 3a and 3b are arranged so as to overlap with each other.

In addition, according to the electro-optic device 1A in this embodiment, the speakers 3a and 3b are arranged in line so as not to be overlapped with each other in plan view, the lengths of the sound conducting channels 9a and 9b may be equalized in both the first sound generating member 21 and the second sound generating member 22, and the phase of the sound outputted from the sound releasing holes 10a and 10b may be equalized, whereby a well balanced sound, which is ear friendly for the viewer, is advantageously achieved.

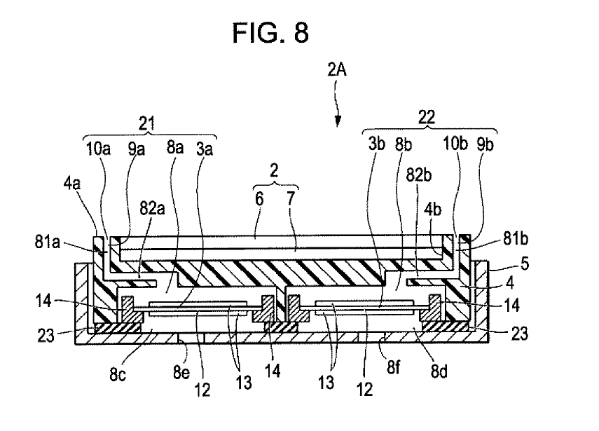

According to the electro-optic device 1A in this embodiment, an example in which the speakers 3a and 3b are supported by the frame 4 by the supporting frame 14 being secured to the lower surface of the frame 4 has been described. However, the invention is not limited to the above-described embodiment and, for example, the speakers 3a and 3b may be supported by the holding frame 5 by the supporting frame 14 being secured to the inner surface of the holding frame 5 via the shock absorbing members 23 as in the case of the electro-optic device 2A shown in FIG. 8. FIG. 8 is an explanatory drawing showing another example of the electro-optic device according to an aspect of the invention, and corresponds to the cross-sectional view taken along the line VIIB, VIII-VIIB, VIII in the plane structure of the electro-optic device shown in FIG. 7A.

### Fifth Embodiment of Electro-Optic Device

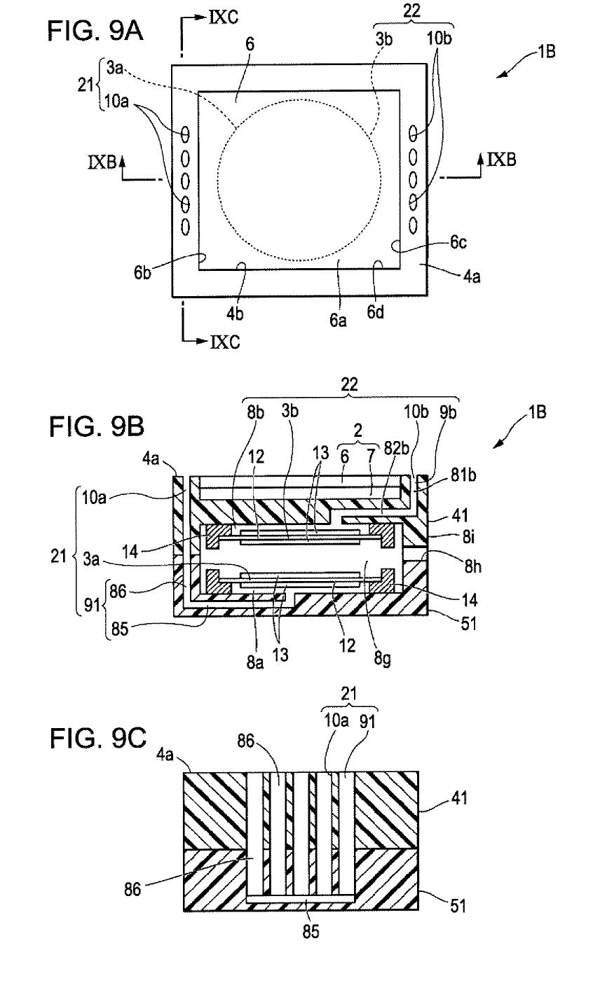

FIGS. 9A to 9C are explanatory drawings showing another example of the electro-optic device according to an aspect of the invention. FIG. 9A illustrates a structure in plan view, FIG. 9B is a cross-sectional view of FIG. 9A taken along the line IXB-IXB and FIG. 9C is a cross-sectional view of FIG. 9A taken along the line IXC-IXC. In the electro-optic device shown in FIGS. 9A to 9C, same parts as in the electro-optic device shown in FIGS. 7A to 7C are represented by same reference numerals and the description will not be made again.

As shown in FIG. 9A, the electro-optic device 1B in this embodiment has the display area 6a of the liquid crystal display device 2 which has a rectangular shape whose difference of length between the long side and the short side is smaller than the electro-optic device 1A shown in FIGS. 7A to 7C. As shown in FIGS. 9A and 9B, the speakers 3a and 3b are arranged so as to overlap with each other in plan view. The speakers 3a and 3b are overlapped with the display area 6a in plan view like the electro-optic device 1A shown in FIGS. 7A to 7C.

According to the electro-optic device 1A shown in FIGS. 7A to 7C, the speakers 3a and 3b are supported by the frame 4. However, according to the electro-optic device 1B shown in FIGS. 9A to 9C, the speaker 3a is supported by the holding frame 51. A space of column shape or a disk shape formed on the side of the holding frame 51 with respect to the speaker 3a (lower side in FIGS. 9B and 9C) which corresponds to a space between the speaker 3a and the inner wall of the holding frame 51 functions as the first air chamber 8a. A space between the speaker 3a and the speaker 3b functions as the second air chamber 8g which is shared by the first sound generating member 21 and the second sound generating member 22. Furthermore, according to the electro-optic device 1B shown in FIGS. 9A to 9C, the side surface 8i is formed by the frame 41 and the holding frame 51 bonded to each other, and the air-ventilation hole 8h is provided on a part of the side surface 8i as shown in FIG. 9B.

According to the electro-optic device 1B in this embodiment, a sound conducting channel 91 of the first sound generating member 21 is formed in the frame 41 and the holding frame 51 as shown in FIG. 9B. The sound conducting channel 91 is provided so as to communicate each of the plurality of sound releasing holes 10a and the first air chamber 8a as shown in FIGS. 9B and 9C. The sound conducting channel 91 includes vertical channels 86 and a horizontal channel 85 as shown in FIGS. 9B and 9C.

Like the electro-optic device 1A in FIGS. 7A to 7C, the vertical channels 86 are provided by the same number as the sound releasing holes 10a in the direction orthogonal to the direction of extension of the display area 6a, have the same shape in plan view as that of the sound releasing hole 10a, and are provided so as to communicate each of the plurality of sound releasing holes 10a and the horizontal channel 85.

Like the electro-optic device 1A in FIGS. 7A to 7C, the horizontal channel 85 connects all the vertical channels 86 which communicates with the respective sound releasing holes 10a and the first air chamber 8a.

According to the electro-optic device 1b in this embodiment, since the speakers 3a, 3b are arranged so as to overlap with each other in plan view, it is difficult to form the sound conducting channels 91, 9b for the first sound generating member 21 and the second sound generating member 22 in the same length. Therefore, according to the electro-optic device 1B in this embodiment, it is preferable to differentiate the cross-sectional areas of the sound conducting channel 91 and the sound conducting channel 9b significantly to compensate the difference in sound quality caused by the difference in length between the sound conducting channels 91 and 9b and equalize the phase of the sounds generated from the sound releasing holes 10a and 10b. More specifically, the difference in sound quality caused by the difference in length of the sound conducting channels 91, 9b are adequately compensated by a method of increasing the cross-sectional area of the sound conducting channel 91, which is the longer one, or a method of reducing the cross sectional area of the sound conducting channel 9b, which is the shorter one, whereby a well balanced sound, which is ear friendly for the viewer, is advantageously achieved.

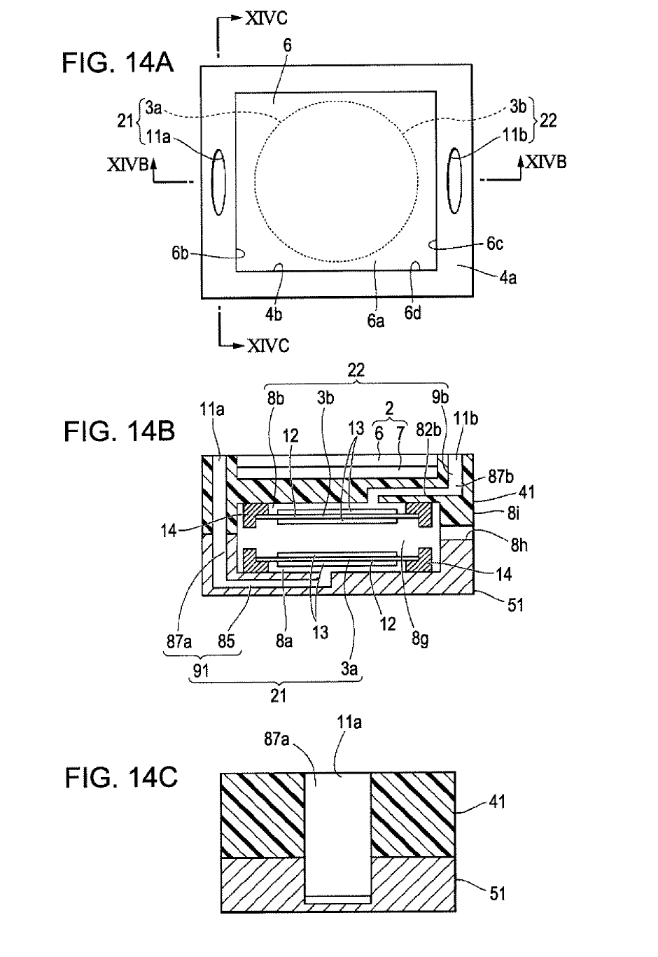

Referring now to FIGS. 14A to 14C, effects of some aspects of the invention will be described. FIGS. 14A to 14C illustrate an example of the electro-optic device having two sound generating members each having one sound releasing hole. FIG. 14A illustrates a structure in plan view, FIG. 14B is a cross-sectional view of FIG. 14A taken along the line XIVB-XIVB, and FIG. 14C is a cross-sectional view of FIG. 14A taken along the line XIVC-XIVC. In the electro-optic device shown in FIGS. 14A to 14C, same parts as in the electro-optic device shown in FIGS. 9A to 9C are represented by same reference numerals and the description will not be made again.

A different point of the electro-optic device shown in FIGS. 14A to 14C from the electro-optic device 1B in FIGS. 9A to 9C is only the sound releasing holes and the vertical channels of the sound conducting channels.

According to the electro-optic device shown in FIGS. 14A to 14C, one each of the sound releasing holes 11a and 11b constitutes the first sound generating member 21 and the second sound generating member 22, as shown in FIG. 14A, and are arranged in the peripheral area 4a located outside the display area 6a in plan view. More specifically, the sound releasing hole 11a of the first sound generating member 21 is arranged near the center of the one side 6b of the rectangular shape, which corresponds to the outer edge 6d of the display area 6a, and the sound releasing hole 11b of the second sound generating member 22 is arranged near the center of the short side 6c opposing the one side 6b of the rectangular shape.

One each of vertical channels 87a and 87b of the sound conducting channels 9a and 9b is provided in the direction orthogonal to the direction of extension of the display area 6a as shown in FIGS. 14B and 14C, having the same shape as the sound releasing holes 11a and 11b in plan view, and one each of the sound releasing holes 11a and 11b and the horizontal channels 85 and 82b are communicated thereby.

Since the electro-optic device shown in FIGS. 14A to 14C is provided with the sound generating members 21 and 22 including the sound conducting channels 91 and 9b having one each of the sound releasing holes 11a and 11b and one each of the vertical channels 87a and 87b respectively like the electro-optic device shown in FIGS. 13A to 13B, the surface area of the peripheral area 4a required for arranging the sound releasing holes 11a and 11b and the vertical channels 87a and 87b cannot be reduced sufficiently.

According to the electro-optic device shown in FIGS. 14A to 14C, even when the plurality of small sound releasing holes 11a and 11b are provided, the arrangement of the sound releasing holes is determined by the arrangement of the vertical channels 83a and 83b like the electro-optic device shown in FIG. 13A to 13C. Therefore, the sound releasing holes cannot be arranged adequately so as to reduce the surface area of the peripheral area 4a.

According to the electro-optic device shown in FIGS. 14A to 14C, since the vertical channels 87a and 87b each constitute a thick and large void in the frame 41 and the holding frame 51 like the electro-optic device shown in FIGS. 13A to 13C, the amount of material which constitutes the frame 41 and the holding frame 51 is remarkably reduced only in the peripheral portions of the vertical channels 87a and 87b, and hence the variation in strength of the frame 41 and the holding frame 51 increases. Therefore, the thickness of the frame 41 and the holding frame 51 in the peripheral portions of the vertical channels 87a and 87b must be secured sufficiently.

In contrast, according to the electro-optic device 1B shown in FIGS. 9A to 9C, since the plurality of the sound releasing holes 10a and 10b and the vertical channels 86 and 81b of the sound conducting channels 91 and 9b which communicate with the sound releasing holes 10a and 10b are provided like the electro-optic device 1A shown in FIGS. 7A to 7C, the surface area of the peripheral area 4a required for arranging the sound releasing holes 10a and 10b and the sound conducting channels 91 and 9b may be reduced.

According to the electro-optic device 1B shown in FIGS. 9A to 9C, the display area 6a of the liquid crystal display device 2 has a rectangular shape whose difference of length between the long side and the short side is smaller than the electro-optic device 1A shown in FIGS. 7A to 7C, the speakers 3a and 3b are arranged so as to overlap with each other in plan view and are overlapped with the display area 6a in plan view. Therefore, the size of the electron optic device may further be reduced in comparison with the electro-optic device 1A shown in FIGS. 7A to 7C.

In addition, according to the electro-optic device 1B shown in FIGS. 9A to 9C, the space between the speaker 3a and the speaker 3b functions as the second air chamber 8g which is shared by the first sound generating member 21 and the second sound generating member 22. Therefore, the thickness of the electro-optic device may be reduced in comparison with the case in which independent second air chambers are provided in the first sound generating member 21 and the second sound generating member 22 respectively.

According to the electro-optic device 1A shown in FIGS. 7A to 7C, the dimensions of the two speakers 3a and 3b must be determined according to half a length of the long side of the display area 6a. However, according to the electro-optic device 1B shown in FIGS. 9A to 9C, the dimensions of the two speakers 3a and 3b may be determined according to the length of the short side of the display area 6a. Therefore, according to the electro-optic device 1B shown in FIGS. 9A to 9C, relatively larger speakers 3a and 3b with respect to the display area 6a may be provided in comparison with the electro-optic device 1A shown in FIGS. 7A to 7C, and hence the sound generating member which has a high effect stereo sound and is superior in sound quality is provided.

Although the electro-optic device 1B shown in FIGS. 9A to 9C has the speakers 3a and 3b arranged so as to be overlapped completely with each other in plan view, the speakers 3a and 3b may also be arranged so as to be overlapped partly with each other in plan view. In this case as well, the electro-optic device may further be reduced, and the speakers 3a and 3b relatively larger with respect to the display area 6a in comparison with the electro-optic device 1A shown in FIGS. 7A to 7C may be provided.

### Sixth Embodiment of Electro-Optic Device

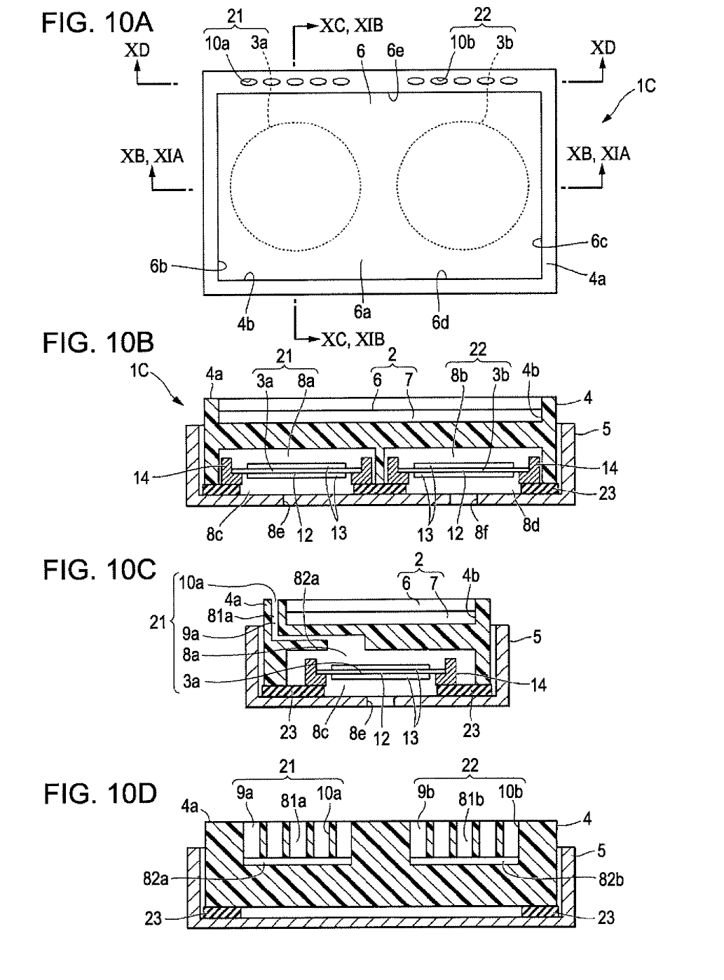

FIGS. 10A to 10D are explanatory drawings showing another example of the electro-optic device according to an aspect of the invention. FIG. 10A illustrates a structure in plan view, FIG. 10B is a cross-sectional view of FIG. 10A taken along the line XB, XIB-XB, XIB, FIG. 10C is a cross-sectional view of FIG. 10A taken along the line XC, XIC-XC, XIC, and FIG. 10D is a cross-sectional view of FIG. 10A taken along the line XD, XID-XD, XID. In the electro-optic device shown in FIGS. 10A to 10D, same parts as in the electro-optic device 2A shown in FIG. 8 are represented by same reference numerals and the description will not be made again.

Unlike the electro-optic device 2A shown in FIG. 8, the electro-optic device 1C in this embodiment includes all the plurality of sound releasing holes 10a and 10b which constitute the first sound generating member 21 and the second sound generating member 22 arranged in the peripheral area 4a along the one long side 6e of the rectangle, which corresponds to the outer edge 6d of the display area 6a as shown in FIG. 10A. Therefore, as shown in FIGS. 10C and 10D, the vertical channels 81a and 81b are also formed in the peripheral area 4a along the one long side 6e of the display area 6a.

According to electro-optic device 1C shown in FIGS. 10A to 10D as well, since the plurality of the sound releasing holes 10a and 10b and the vertical channels 81a and 81b of the sound conducting channels 9a and 9b which communicate with the sound releasing holes 10a and 10b are provided like the electro-optic device 1A shown in FIGS. 7A to 7C, the surface area of the peripheral area 4a required for arranging the sound releasing holes 10a and 10b and the sound conducting channels 9a and 9b may be reduced.

According to the electro-optic device 1C shown in FIGS. 10A to 10D, since the display area 6a has a rectangular shape and all the plurality of sound releasing holes 10a, 10b are arranged along the long side 6e as one side of the rectangle, it is not necessary to secure the surface area for arranging the sound releasing holes 10a and 10b and the sound conducting channels 9a and 9b in the peripheral area 4a along the three sides except for the long side 6e, and the surface area of the peripheral area 4a required for arranging the sound releasing holes 10a and 10b and the sound conducting channels 9a and 9b may be reduced in comparison with the case in which the plurality of sound releasing holes 10a and 10b are arranged along the short sides 6b and 6c of the rectangle like the electro-optic device 1A shown in FIGS. 7A to 7C.

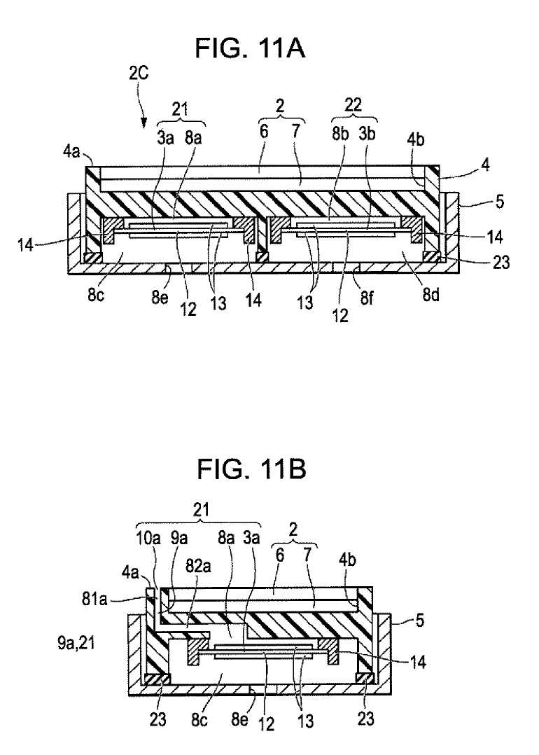

The electro-optic device 1C shown in FIGS. 10A to 10D has been described with an example in which the speakers 3a and 3b are supported by the holding frame 5 by the supporting frame 14 being secured to the inner surface of the holding frame 5 via the shock absorbing members 23. However, the invention is not limited to the above-described embodiments and, for example, the speakers 3a and 3b are supported by the frame 4 by the supporting frame 14 secured to the lower surface of the frame 4 like the electro-optic device 2C shown in FIGS. 11A and 11B. FIGS. 11A and 11B are explanatory drawings showing another example of the electro-optic device according to an aspect of the invention. FIG. 11A corresponds to the cross-sectional view taken along the line XB, XIB-XB, XIB in the plane structure of the electro-optic device shown in FIG. 10A, and FIG. 11B is a cross-sectional view of FIG. 10A taken along the line XC, XIC-XC, XIC.

### Seventh Embodiment of Electro-Optic Device

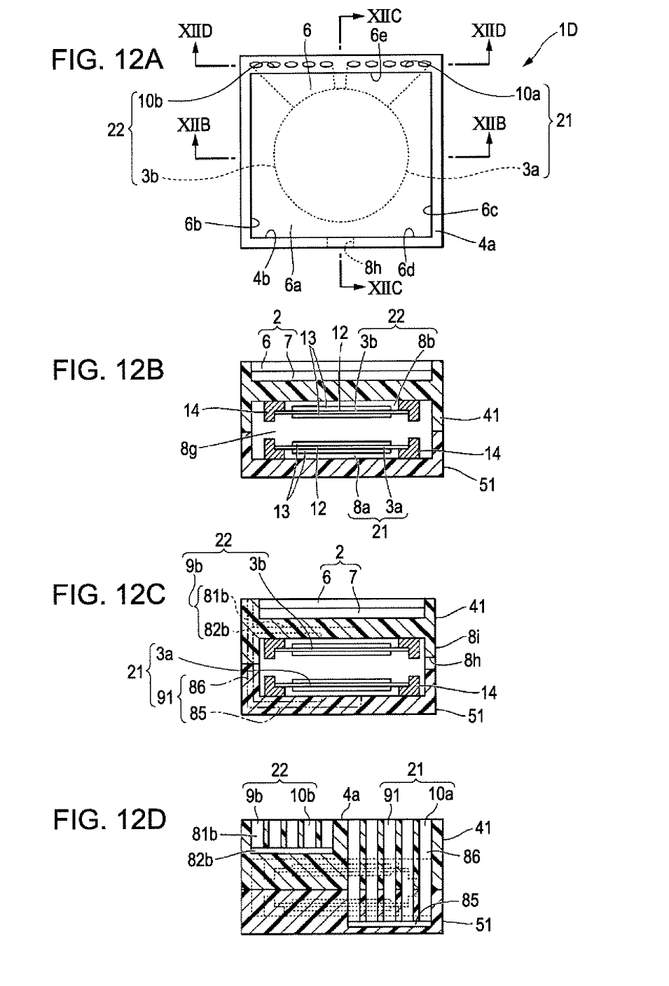

FIGS. 12A to 12D are explanatory drawings showing another example of the electro-optic device according to an aspect of the invention. FIG. 12A illustrates a structure in plan view, FIG. 12B is a cross-sectional view of FIG. 12A taken along the line XIIB-XIIE, FIG. 12C is a cross-sectional view of FIG. 12A taken along the line XIIC-XIIC, and FIG. 12D is a cross-sectional view of FIG. 12A taken along the line XIID-XIID. In the electro-optic device shown in FIGS. 12A to 12D, same parts as in the electro-optic device shown in FIGS. 9A to 9C are represented by same reference numerals and the description will not be made again.

Unlike the electro-optic device shown in FIGS. 9A to 9C, an electro-optic device 1D in this embodiment also includes all the plurality of sound releasing holes 10a and 10b which constitute the first sound generating member 21 and the second sound generating member 22 arranged in the peripheral area 4a along the one long side 6e of the rectangle, which corresponds to the outer edge 6d of the display area 6a as shown in FIG. 12A. Therefore, as shown in FIGS. 12B and 12D, the vertical channels 81a and 81b are also formed in the peripheral area 4a along the one long side 6e of the display area 6a.

According to the electro-optic device 1D shown in FIGS. 12A to 12D as well, since the plurality of the sound releasing holes 10a and 10b and the vertical channels 86 and 81b of the sound conducting channels 91 and 9b which communicate with the sound releasing holes 10a and 10b are provided like the electro-optic device 1A shown in FIGS. 7A to 7C the surface area of the peripheral area 4a required for arranging the sound releasing holes 10a and 10b and the sound conducting channels 91 and 9b may be reduced.

According to the electro-optic device 1D shown in FIGS. 12A to 12D, since the display area 6a has a rectangular shape and all the plurality of sound releasing holes 10a, 10b are arranged along the long side 6e as one side of the rectangle, the surface area required for arranging the sound releasing holes 10a and 10b and the sound conducting channels 91 and 9b may be reduced in comparison with the case in which the plurality of sound releasing holes 10a and 10b are arranged along the short sides 6b and 6c of the rectangle like the electro-optic device 1A shown in FIGS. 7A to 7C.

According to the electro-optic device 1D shown in FIGS. 12A to 12D, the display area 6a of the liquid crystal display device 2 has a rectangular shape whose difference of length between the long side and the short side is smaller than the electro-optic device 1A shown in FIGS. 7A to 7C, the speakers 3a and 3b are arranged so as to overlap with each other in plan view and are overlapped with the display area 6a in plan view. Therefore, the size of the electro-optic device may further be reduced in comparison with the electro-optic device 1A shown in FIGS. 7A to 7C, and relatively larger speakers 3a and 3b with respect to the display area 6a may be provided in comparison with the electro-optic device 1A shown in FIGS. 7A to 7C.

### Other Embodiments of Electro-Optic Device

Although some aspects of the invention has been described on the basis of preferred embodiments, the invention is not limited to these embodiments, and various modification may be made within the scope of the invention described in Claims.

For example, although the liquid crystal display device is employed as the display unit of the electro-optic device in the description shown above, other display devices, such as the EL display device or the plasma display device may be employed instead of the liquid crystal display device. Although the sound generating member employing the oscillating plate and the piezoelectric element has been described as an example of the speaker, the sound generating member is not limited to speaker with such a structure, and the sound generating member provided with speakers in various structures may be used as needed.

### First Embodiment of Electronic Apparatus

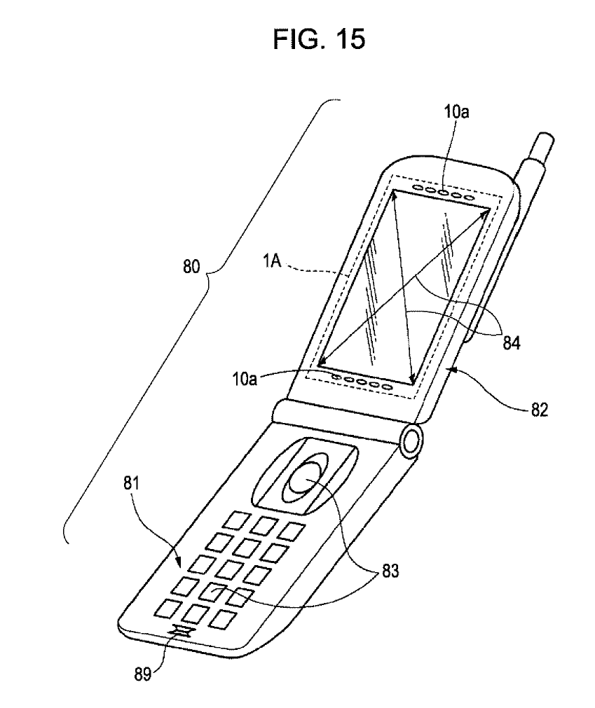

FIG. 15 is a perspective view showing a mobile phone as an example of the electronic apparatus according to an aspect of the invention. A mobile phone 80 shown in FIG. 15 includes a body 81 and a display body 82 provided on the body 81 so as to be capable of opening and closing. The body 81 includes operating buttons 83 arranged thereon. The electro-optic device 1A shown in FIGS. 1A to 1C or in FIGS. 7A to 7C is arranged in the interior of the display body 82.

The mobile phone 80 in FIG. 15 is provided with the electro-optic device 1A which enables reduction of the surface area of the peripheral area, and hence a compact profile is achieved. It is also possible to arrange the electro-optic devices shown in FIG. 2 to FIG. 6B or FIG. 8 to FIG. 12D instead of the electro-optic device 1A in the mobile phone 80 shown in FIG. 15.

### Other Embodiments of Electronic Apparatus

Although some aspects of the invention has been described on the basis of preferred embodiments, the invention is not limited to these embodiments, and various modification may be made within the scope of the invention described in Claims. For example, the electronic apparatus according to the aspects of the invention may be personal computers, liquid crystal TVs, digital still cameras, watches, viewfinder type or monitor-direct-vision video tape recorders, car navigation systems, pagers, electronic data books, calculators, word processors, workstations, TV phones, POS terminals, and other various types of apparatus in addition to the mobile phone described above.

The entire disclosure of Japanese Patent Application Nos: 2006-080313, filed Mar. 23, 2006 and 2006-080314, filed Mar. 23, 2006 are expressly incorporated by reference herein.

What is claimed is:

1. An electro-optic device comprising: a display unit having a display area and a plurality of sound generating members,
wherein the plurality of sound generating members each include a speaker which is arranged so as to overlap the display area in plan view, and a sound releasing hole that outputs sounds generated by the speaker toward the outside, wherein the plurality of sound releasing holes which constitutes the plurality of sound generating members are arranged on the outside of the display area in plan view along part of the sides of the display area.

2. The electro-optic device according to claim 1, wherein the dimensions of the sound releasing hole are configured in such a manner that the dimension of the direction orthogonal to the direction extending along an outer edge of the display area is shorter than the dimension of the direction along the outer edge of the display area.

3. The electro-optic device according to claim 1, wherein the plurality of speakers which constitute the plurality of sound generating members are arranged in line so as not overlap with each other in plan view.

4. The electro-optic device according to claim 1, wherein the plurality of speakers which constitute the plurality of sound generating members are arranged so as to overlap at least partly with each other in plan view.

5. An electro-optic device comprising:
a display unit having a display area and a sound generating member,
wherein the sound generating member includes a speaker arranged so as to overlap the display area in plan view, an air chamber which includes with the speaker therein, a plurality of sound releasing holes arranged in a peripheral area located on the outside of the display area in plan view, and a plurality of branched sound conducting channels each of which communicates each of the plurality of sound releasing holes and the air chamber.

6. The electro-optic device according to claim 5, wherein the plurality of sound releasing holes are arranged in a row along the outer edge of the display area.

7. The electro-optic device according to claim 5, wherein the display area has a rectangular shape and all the plurality of sound releasing holes are arranged along one side of the rectangle.

8. The electro-optic device according to claim 5, wherein the plurality of sound generating members may be provided.

9. The electro-optic device according to claim 8, wherein the plurality of speakers which constitute the plurality of sound generating members are arranged so as not to overlap with each other in pan view.

10. The electro-optic device according to claim 8, wherein the plurality of speakers which constitute the plurality of sound generating members may be arranged so as to overlap at least partly with each other in plan view.

11. The electro-optic device according to claim 8, wherein the display area has a rectangular shape, the plurality of sound generating members are divided into a first group and a second group, the plurality of sound releasing holes of the sound generating members which constitute the first group are all arranged along one side of the rectangle, and the plurality of sound releasing holes of the sound generating members which constitute the second group are all arranged along the side opposing one side of the rectangle.

12. The electro-optic device according to claim 5, wherein the dimensions of the sound releasing hole are configured in such a manner that the dimension of the direction orthogonal to the direction extending along an outer edge of the display area is shorter than the dimension of the direction along the outer edge of the display area.

13. An electronic apparatus comprising any one of electro-optic devices according to claim 1.
